(19) United States
(12) Patent Application Publication
(10) Pub. No.: US 2024/0412071 A1
(43) Pub. Date: Dec. 12, 2024

(54) LEARNING METHOD AND RECORDING MEDIUM

(71) Applicant: Panasonic Intellectual Property Corporation of America, Torrance, CA (US)

(72) Inventors: Masashi OKADA, Osaka (JP); Hiroki Nakamura, Osaka (JP)

(21) Appl. No.: 18/812,035

(22) Filed: Aug. 22, 2024

Related U.S. Application Data
(63) Continuation of application No. PCT/JP2023/004658, filed on Feb. 10, 2023.
(60) Provisional application No. 63/315,182, filed on Mar. 1, 2022.

(30) Foreign Application Priority Data
Nov. 18, 2022 (JP) 2022-185097

(51) Int. Cl. G06N 3/088; G06N 3/045

(52) U.S. Cl. CPC G06N 3/088; G06N 3/045

(57) ABSTRACT

A self-supervised representation learning method includes: outputting, using one of two neural networks, a first parameter that is a parameter of a probability distribution from one of two items of image data obtained by applying data augmentation to one training image obtained from training data; outputting a second parameter that is a parameter of a probability distribution from an other one of the two items of image data, using an other one of the two neural networks; and training the two neural network to optimize an objective function for bringing the two items of image data close to each other, the objective function including a likelihood of the probability distribution of the second parameter.

### CROSS REFERENCE TO RELATED APPLICATIONS

This is a continuation application of PCT International Application No. PCT/JP2023/004658 filed on Feb. 10, 2023, designating the United States of America, which is based on and claims priority of U.S. Provisional Patent Application No. 63/315,182 filed on Mar. 1, 2022, and Japanese Patent Application No. 2022-185097 filed on Nov. 18, 2022. The entire disclosures of the above-identified applications, including the specifications, drawings and claims are incorporated herein by reference in their entirety.

### FIELD

The present disclosure relates to a learning method and a recording medium.

### BACKGROUND

As a method of pre-training neural networks without labels prepared by humans, a self-supervised learning method is available.

In a self-supervised learning method, unique labels are generated mechanically from image data itself, so that image representations are learned (for example, Non Patent Literature (NPL) 1).

NPL 1 proposes a learning method in which data augmentation is applied to the same image data to obtain different image data and learning is performed to maximize the similarity between different image data representations. This leads to the same accuracy as conventional unsupervised representation learning without the use of negative pairs and momentum encoders conventionally used in contrastive learning.

### CITATION LIST

### Non Patent Literature

NPL 1: Chen, X. and He, K.: Exploring simple siamese representation learning, CVPR (2021).
NPL 2: De Cao, N. and Aziz, W.: The Power Spherical distribution, ICML, INNF+ (2020).
NPL 3: Hafner, Danijar, et al. “Learning latent dynamics for planning from pixels.” International conference on machine learning. PMLR, 2019.
NPL 4: Zhu, Yuke, et al. “robosuite: A modular simulation framework and benchmark for robot learning.” arXiv preprint arXiv: 2009.12293 (2020).

### SUMMARY

### Technical Problem

However, although the learning method disclosed in NPL 1 is capable of using many kinds of images obtained by data augmentation for learning, the images may include uncertain images that are caused by data augmentation. This adversely affects learning. In other words, the learning method disclosed in NPL 1 does not take image uncertainty into account.

The present disclosure has been conceived in view of the above circumstances. An object of the present disclosure is to provide a learning method and the like that is capable of taking into account image uncertainty in self-supervised learning.

### Solution to Problem

A learning method according to one aspect of the present disclosure is a self-supervised representation learning method performed by a computer. The self-supervised representation learning method includes: outputting, using one of two neural networks, a first parameter that is a parameter of a probability distribution from one of two items of image data obtained by applying data augmentation to one training image obtained from training data; outputting, using an other one of the two neural networks, a second parameter that is a parameter of a probability distribution from an other one of the two items of image data; and training the two neural networks to optimize an objective function for bringing the two items of image data close to each other, the objective function including a likelihood of the probability distribution of the second parameter.

These general and specific aspects may be implemented using a system, a device, a method, an integrated circuit, a computer program, or a computer-readable recording medium such as a CD-ROM, or any combination of systems, devices, methods, integrated circuits, computer programs, or computer-readable recording media.

### Advantageous Effects

According to the present disclosure, it is possible to realize a learning method and the like that is capable of taking into account image uncertainty in self-supervised learning.

### BRIEF DESCRIPTION OF DRAWINGS

These and other advantages and features will become apparent from the following description thereof taken in conjunction with the accompanying Drawings, by way of non-limiting examples of embodiment disclosed herein.

FIG. 1 is a block diagram illustrating an example of a configuration of a learning system according to an embodiment.

FIG. 2 conceptually illustrates processes performed by the learning system according to the embodiment.

FIG. 3 is a flowchart illustrating an operation of a learning device according to the embodiment.

FIG. 4 conceptually illustrates a self-supervised learning method according to a comparative example.

FIG. 5 conceptually illustrates the self-supervised learning method according to the comparative example.

FIG. 6 illustrates an example of an image with high uncertainty and an image with low uncertainty that are obtained by data augmentation according to the embodiment.

FIG. 7 illustrates another example of an image with high uncertainty and an image with low uncertainty that are obtained by data augmentation according to the embodiment.

FIG. 8 conceptually illustrates processes performed by a learning system according to Example 1.

FIG. 9 conceptually illustrates an example of the von Mises-Fischer distribution.

FIG. 10 illustrates an example of an architecture for implementing the learning system according to Example 1.

FIG. 11 illustrates an example of pseudocode of an algorithm according to Example 1.

FIG. 12 illustrates pseudocode of an algorithm according to a comparative example.

FIG. 13 conceptually illustrates processes performed by a learning system according to Example 2.

FIG. 14 conceptually illustrates an example of the Power Spherical distribution.

FIG. 15 illustrates an example of an architecture for implementing the learning system according to Example 2.

FIG. 16 illustrates an example of pseudocode of an algorithm according to Example 2.

FIG. 17 illustrates a relationship between concentration parameter, cosine similarity, and loss in the learning system according to Example 2.

FIG. 18 illustrates results of evaluating performance of the learning system according to Example 2 using a dataset of an experiment example.

FIG. 19 illustrates results of evaluating image uncertainty after data augmentation used in the experiment example.

FIG. 20 illustrates predicted concentration parameters for images after data augmentation.

FIG. 21 conceptually illustrates processes performed by a learning system according to Variation 1.

FIG. 22 conceptually illustrates a joint distribution of N discrete probability distributions (K classes).

FIG. 23A illustrates an example of a camera image that is input to a controller to cause a robot to solve a task of lifting a target object.

FIG. 23B illustrates learning curves of simulation experiments which cause the robot to solve the task of lifting the target object.

FIG. 24A illustrates an example of a camera image that is input to the controller to cause the robot to solve a task of opening a door.

FIG. 24B illustrates learning curves of simulation experiments which cause the robot to solve the task of opening the door.

FIG. 25A illustrates an example of a camera image that is input to the controller to cause the robot to solve a task of inserting a peg into a hole.

FIG. 25B illustrates learning curves of simulation experiments which cause the robot to solve the task of inserting the peg into the hole.

FIG. 26 conceptually illustrates processes performed by a learning system according to Variation 2.

FIG. 27 conceptually illustrates a formula for analytically calculating an objective function according to Variation 2.

### DESCRIPTION OF EMBODIMENT

A learning method according to one aspect of the present disclosure is a self-supervised representation learning method performed by a computer. The self-supervised representation learning method includes: outputting, using one of two neural networks, a first parameter that is a parameter of a probability distribution from one of two items of image data obtained by applying data augmentation to one training image obtained from training data; outputting, using an other one of the two neural networks, a second parameter that is a parameter of a probability distribution from an other one of the two items of image data; and training the two neural networks to optimize an objective function for bringing the two items of image data close to each other, the objective function including a likelihood of the probability distribution of the second parameter.

This allows the two neural networks to learn parameters that can take image uncertainty into account, so that self-supervised learning can be performed that takes image uncertainty into account.

Here, for example, it may be that the self-supervised representation learning method includes: performing a sampling process for generating a random number that follows the probability distribution of the first parameter; and calculating a likelihood of the probability distribution of the first parameter, using the random number generated. It may be that in the training of the two neural networks, the two neural networks are trained by inputting the random number generated to the probability distribution of the second parameter to calculate the likelihood of the probability distribution of the second parameter, and optimizing the objective function that includes the likelihood of the probability distribution of the second parameter calculated.

With this, the objective function can be calculated approximately. This allows the computer to optimize the objective function, so that the two neural networks are capable of learning parameters that can take image uncertainty into account.

Moreover, for example, it may be that the probability distribution of the first parameter is a probability distribution defined by a delta function, the second parameter is a parameter that indicates a mean direction and a concentration, and the probability distribution of the second parameter is a von Mises-Fischer distribution defined by the mean direction and the concentration.

In such a manner, by using the von Mises-Fischer distribution, which is a hypersphere, as the probability distribution that the parameter of the latent variable follows, the two neural networks are capable of learning parameters that can take image uncertainty into account.

Moreover, for example, it may be that the probability distribution of the first parameter is a probability distribution defined by a delta function, the second parameter is a parameter that indicates a mean direction and a concentration, and the probability distribution of the second parameter is a Power Spherical distribution defined by the mean direction and the concentration.

In such a manner, by using the Power Spherical distribution, which is a hypersphere, as the probability distribution that the parameter of the latent variable follows, the two neural networks are capable of learning parameters that can take image uncertainty into account.

Moreover, for example, it may be that each of the probability distribution of the first parameter and the probability distribution of the second parameter is a joint distribution of one or more discrete probability distributions, and each of the one or more discrete probability distributions includes two or more categories.

In such a manner, by using the joint distribution of discrete probability distributions as the probability distribution that the parameter of the latent variable follows, the two neural networks are capable of learning parameters that can take image uncertainty into account.

Moreover, for example, it may be that the objective function includes a cross-entropy of the probability distribution of the first parameter and a cross-entropy of the probability distribution of the second parameter, the cross-entropy of the probability distribution of the second parameter includes the likelihood of the probability distribution of the second parameter, and in the training of the two neural networks, the two neural networks are trained to optimize the objective function by calculating the cross-entropy of the probability distribution of the first parameter and the cross-entropy of the probability distribution of the second parameter approximately or analytically.

With this, the objective function can be calculated analytically. This allows the computer to optimize the objective function, so that the two neural networks are capable of learning parameters that can take image uncertainty into account.

A recording medium according to one aspect of the present disclosure is a non-transitory computer-readable recording medium for use in a computer, the recording medium having recorded thereon a computer program for causing the computer to execute: outputting, using one of two neural networks, a first parameter that is a parameter of a probability distribution from one of two items of image data obtained by applying data augmentation to one training image obtained from training data; outputting, using an other one of the two neural networks, a second parameter that is a parameter of a probability distribution from an other one of the two items of image data; and training the two neural networks to optimize an objective function for bringing the two items of image data close to each other, the objective function including a likelihood of the probability distribution of the second parameter.

These general and specific aspects may be implemented using a system, a device, a method, an integrated circuit, a computer program, or a computer-readable recording medium such as a CD-ROM, or any combination of systems, devices, methods, integrated circuits, computer programs, or computer-readable recording media. Hereinafter, an embodiment according to the present disclosure will be described in greater detail with reference to the accompanying Drawings. The exemplary embodiment described below shows a specific example of the present disclosure. The numerical values, shapes, structural elements, steps, the processing order of the steps etc. shown in the following embodiment are mere examples, and therefore do not limit the present disclosure. Therefore, among the structural elements in the following embodiment, those not recited in any one of the independent claims are described as optional elements. In the following embodiment, each feature may be combined.

### Embodiment

Hereinafter, a learning method and the like according to the present disclosure will be described with reference to the drawings.

### [1. Learning System 1]

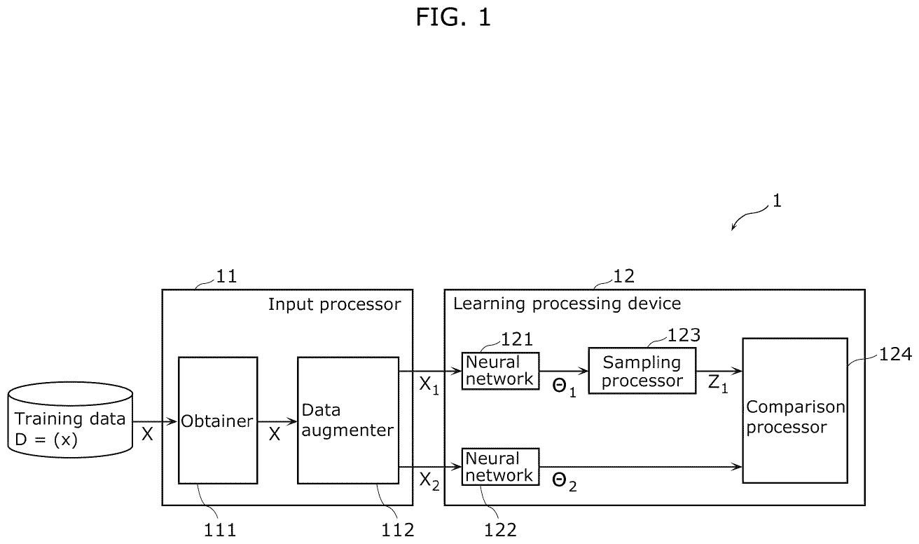

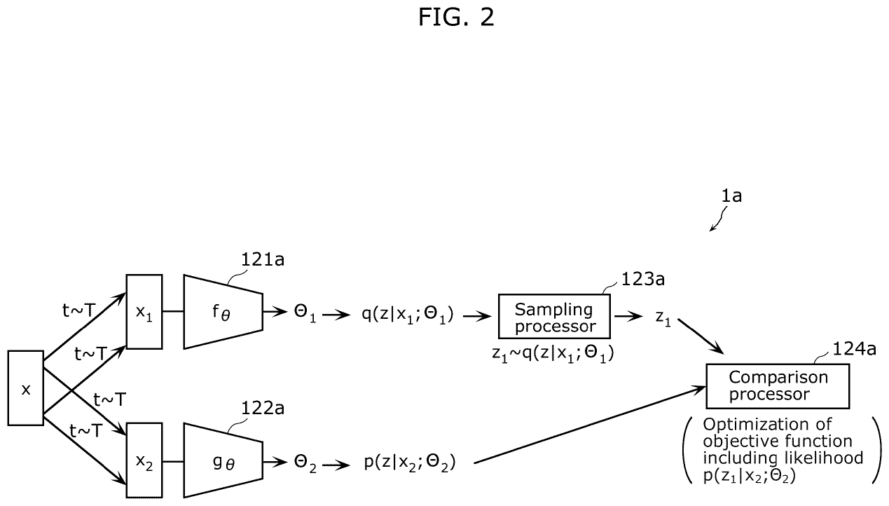

FIG. 1 is a block diagram illustrating an example of a configuration of learning system 1 according to the present disclosure. FIG. 2 conceptually illustrates processes performed by learning system 1 according to the present embodiment. Learning system 1a illustrated in FIG. 2 is an example of a specific aspect of learning system 1.

Learning system 1 is for performing self-supervised representation learning that takes image uncertainty into account. In the present disclosure, learning system 1 includes input processor 11 and learning processing device 12, as illustrated in FIG. 1. Learning system 1 may include learning processing device 12 without input processor 11.

### [1.1 Input Processor 11]

Input processor 11 includes a computer including, for example, a memory and a processor (microprocessor). Input processor 11 realize various functions by the processor executing a control program stored in the memory. Input processor 11 according to the present embodiment includes obtainer 111 and data augmenter 112, as illustrated in FIG. 1.

Obtainer 111 obtains one training image from training data. In the present embodiment, obtainer 111 obtains one training image X from training data D, for example, as illustrated in FIG. 1.

Data augmenter 112 applies data augmentation to the one training image obtained by obtainer 111. In the embodiment, data augmenter 112 applies data augmentation to one training image X obtained by obtainer 111 to obtain two different items of image data X₁ and X₂, for example, as illustrated in FIG. 1. Here, the term “data augmentation” refers to the process of augmenting data by applying a conversion process to image data. Examples of the conversion process include rotation process, translation process, enlargement process, reduction process, left-right flipping process, up-down flipping process, and color conversion process. Learning system 1a in FIG. 2 conceptually illustrates that data augmentation is applied to training image X to obtain two different items of image data X₁ and X₂.

### [1.2 Learning Processing Device 12]

Learning processing device 12 includes a computer including, for example, a memory and a processor (microprocessor). Learning processing device 12 realizes various functions by the processor executing a control program stored in the memory. As illustrated in FIG. 1, learning processing device 12 according to the present embodiment includes neural network 121, neural network 122, sampling processor 123, and comparison processor 124.

Neural network 121 is one of two neural networks to be trained by learning system 1. Neural network 121 outputs a first parameter that is a probability distribution parameter from one of two items of image data obtained by applying data augmentation to one training image obtained from training data.

In the present embodiment, as illustrated in FIG. 1, for example, neural network 121 predicts and outputs first parameter Θ₁ that is a probability distribution parameter as features from image data X₁ output from input processor 11.

Neural network 121a illustrated in FIG. 2 is an example of a specific aspect of neural network 121. Neural network 121a is represented as an encoder with f as a function indicating the prediction process of feature representation and θ as a plurality of model parameters including weights. Neural network 121a predicts first parameter Θ₁, which is a parameter of probability distribution q, as a latent variable of feature representation by operating f_{θ} on image data X₁ obtained by applying data augmentation to one training image X. As illustrated in FIG. 2, probability distribution q can be expressed as probability distribution q(z|x₁;Θ₁) determined by first parameter Θ₁.

Neural network 122 is the other one of the two neural networks to be trained by learning system 1. Neural network 122 outputs a second parameter that is a probability distribution parameter from the other one of the two items of image data obtained by data augmentation.

As illustrated in FIG. 1, for example, in the present embodiment, neural network 122 predicts and outputs second parameter Θ₂ that is a probability distribution parameter as features from image data X₂ output from input processor 11.

Neural network 122a illustrated in FIG. 2 is an example of a specific aspect of neural network 122. Neural network 122a is represented as an encoder with g as a function indicating the prediction process of feature representation and θ as a plurality of model parameters including weights. Neural network 122a predicts second parameter Θ₂, which is a parameter of probability distribution p, as a latent variable of feature representation by operating g_{θ} on image data X₂ obtained by applying data augmentation to one training image X. As illustrated in FIG. 2, probability distribution p can be expressed as probability distribution p(z|x₂; Θ₂) determined by second parameter Θ₂.

In the present embodiment, neural network 121 and neural network 122 are trained by interpreting neural network 121 and neural network 122 as encoders that transform input data into latent variables that follow probability distributions. Furthermore, the probability distribution is not a probability distribution defined by a normal distribution, but a probability distribution defined by, for example, a hypersphere, a delta function, or a joint distribution of discrete probability distributions, as described below. With this, neural network 121 and neural network 122 are capable of learning parameters that can take image uncertainty into account by learning predicting parameters of the probability distributions as latent variables in feature representation.

Neural Network 121 and Neural Network 122 are, for example, Siamese Networks including a ResNet (Residual Network) backbone, but are not limited to such an example. Neural network 121 and neural network 122 each may be configured from a deep learning model that includes a convolution neural networks (CNN) layer, and is capable of predicting the parameter of a probability distribution as a latent representation of feature representation from image data.

Sampling processor 123 performs a sampling process. In the present embodiment, as illustrated in FIG. 1, for example, sampling processor 123 obtains features z₁ from first parameter Θ₁ output from neural network 121 by performing sampling according to probability distribution q of first parameter Θ₁. Here, sampling processor 123 may, for example, perform a sampling process that generates a random number that is in accordance with the probability distribution of first parameter Θ₁ and obtain features z₁ from first parameter Θ₁.

Sampling processor 123a illustrated in FIG. 2 is an example of a specific aspect of sampling processor 123, and obtains features z₁ sampled according to probability distribution q(z|x₁;Θ₁) of first parameter Θ₁.

It can be interpreted as a process for approximately calculating an objective function described below. Sampling processor 123 does not have to be included when the probability distribution of the first parameter is a probability distribution defined by a delta function, as described below.

Comparison processor 124 trains two neural networks that are neural network 121 and neural network 122 by optimizing neural network 121 and neural network 122 through comparison processes.

In the present embodiment, as illustrated in FIG. 1, for example, comparison processor 124 compares features z₁ obtained from image data X₁ using neural network 121 and the probability distribution of the second parameter that is the features obtained from image data X₂ using neural network 122. Comparison processor 124 trains neural network 121 and neural network 122 that are two neural networks by optimizing the objective function obtained by the comparison process. For example, comparison processor 124 may calculate the likelihood of the probability distribution of the second parameter by inputting the random number generated by sampling processor 123 into the probability distribution of the second parameter, and calculate an objective function that includes the calculated likelihood. Comparison processor 124 may then train the two neural networks by optimizing the calculated objective function.

Comparison processor 124a illustrated in FIG. 2 is an example of a specific aspect of comparison processor 124. Comparison processor 124a calculates an objective function including likelihood p(z₁|x₂; Θ₂) in probability distribution p(z|x₂;Θ₂) of second parameter Θ₂ and optimizes the objective function. The likelihood can express how well the probability distribution corresponds to the actual observed data, and is defined by the input of the observed data to the probability distribution multiplied by its output. Therefore, comparison processor 124a is capable of calculating the likelihood by inputting features z₁ obtained by the sampling process into probability distribution p(z|x₂;Θ₂) of the second parameter.

In such a manner, comparison processor 124 is capable of training the two neural networks to optimize the objective function that includes the likelihood of the probability distribution of the second parameter and is for bringing two items of image data obtained by data augmentation close to each other. With this, such learning can be performed that, when two items of image data obtained by data augmentation includes an image with high uncertainty, contribution of such an image to learning is small, and when the two items of image data obtained by data augmentation includes an image with low uncertainty, contribution of such an image to learning is large.

Comparison processor 124 is capable of calculating and optimizing an objective function using Kullback-Leibler divergence (KL divergence) as the objective function. Here, the KL divergence is capable of quantifying how similar two probability distributions are (i.e., similarity). When KL divergence is used as a loss function, KL divergence can be expressed using cross-entropy. In this case, the cross-entropy term with respect to the random numbers generated according to the probability distribution of the first parameter is constant.

### [1.3 Operation of Learning Processing Device 12]

The operation of learning processing device 12 configured as described above that is the learning method of learning processing device 12 will be described below.

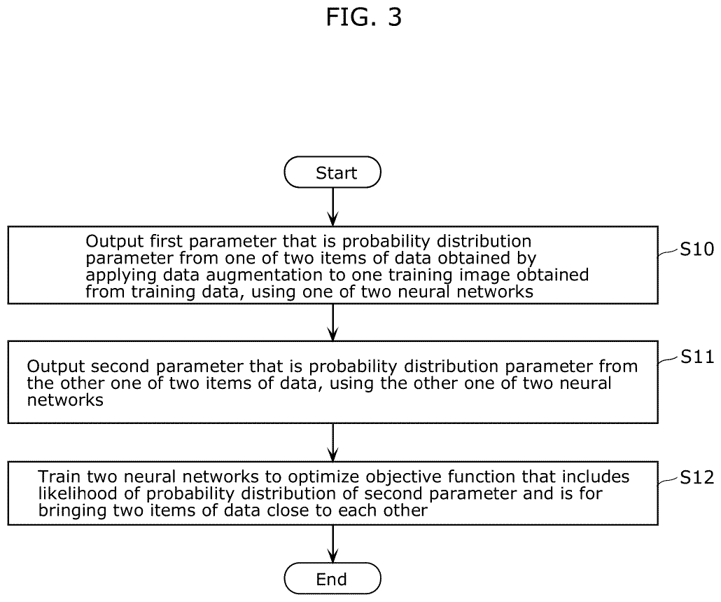

FIG. 3 is a flowchart illustrating an operation of learning processing device 12 according to the present embodiment.

Learning processing device 12 includes a processor and memory, and performs the following steps S11 and S12 using the processor and the program recorded in the memory.

More specifically, learning processing device 12 first outputs, using one of the two neural networks, the first parameter that is a probability distribution parameter from one of the two items of image data obtained by applying data augmentation to one training image obtained from training data (S10). In the present embodiment, as illustrated in FIG. 1, for example, learning processing device 12 outputs, using neural network 121, first parameter Θ₁, which is a probability distribution parameter, from image data X₁ obtained by applying data augmentation to one training image X obtained from training data D.

Next, learning processing device 12 outputs, using the other one of the two neural networks, the second parameter that is a probability distribution parameter from the other one of the two items of image data obtained by applying data augmentation to one training image obtained from training data (S11). In the present embodiment, as illustrated in FIG. 1, for example, learning processing device 12 outputs, using neural network 122, second parameter Θ₂ that is a probability distribution parameter from image data X₂ obtained by applying data augmentation to one training image X obtained from training data D.

Next, learning processing device 12 trains the two neural networks to optimize an objective function that is for bringing two items of image data close to each other and includes the likelihood of the probability distribution of the second parameter (S12). In the present embodiment, as illustrated in FIG. 2, for example, learning processing device 12 trains neural network 121 and neural network 122 by calculating and optimizing an objective function including likelihood p(z₁|x₂;Θ₂) in probability distribution p(z|x₂;Θ₂) of second parameter Θ₂.

### 2. Advantageous Effects, Etc.

First, as a comparative example, a description will be given to the case where the learning method disclosed in NPL 1 that does not take image uncertainty into account may adversely affect learning.

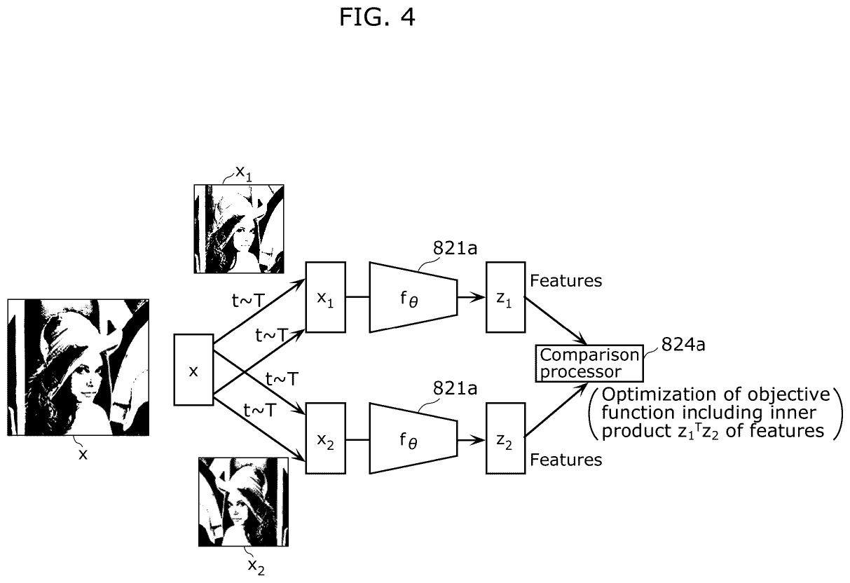

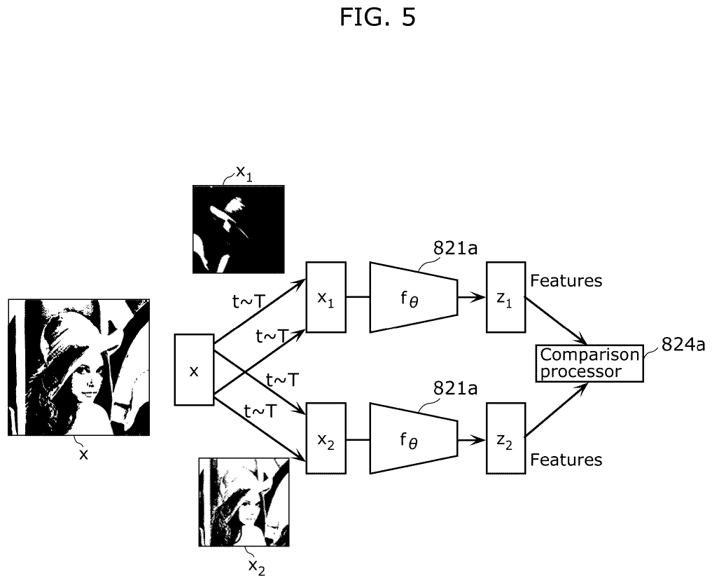

FIG. 4 and FIG. 5 each conceptually illustrate a self-supervised learning method according to the comparative example. Neural network 821a illustrated in FIG. 4 and FIG. 5 is configured from a Siamese network, and is represented by an encoder that operates function f with a plurality of model parameters including weights as Θ.

In the self-supervised learning method according to the comparative example, as illustrated in FIG. 4, data is augmented by applying different image processing to given image data X to obtain image data X₁ and X₂. Comparison processor 824a then trains neural networks 821a so that features z₁ and z₂ obtained by encoding image data X₁ and X₂ with neural networks 821a are consistent. Specifically, comparison processor 824a optimizes an objective function including inner product z₁^{T}z₂ of features z₁ and z₂ to maximize the similarity between the representations of image data X₁ and X₂ illustrated in FIG. 4. With this, it is possible to train neural networks 821a.

However, since the hyperparameters of the image processing for data augmentation are determined randomly, some image processing may cause the loss of valid features of image data X. FIG. 5 conceptually illustrates an example of a case in which valid features of image data X are lost. In other words, in the example illustrated in FIG. 5, data is augmented by applying different image processing to given image data X to obtain image data X₁ and X₂. However, it is indicated that valid features of image data X are lost in image data X₂, so that image data X₂ is image data with high uncertainty. In this case, it is highly likely that features z₂ obtained by encoding image data X₂ using neural network 821a are not features that represent valid features of image data X₂. As a result, features z₂ may hinder the optimization of the objective function including inner product z₁^{T}z₂ of features z₁ and z₂, i.e., may reduce learning performance such as accuracy.

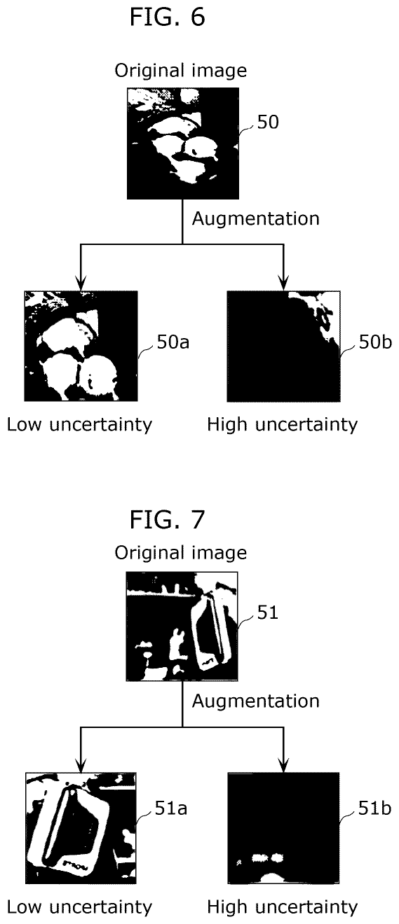

Next, images with high uncertainty and low uncertainty will be described with reference to FIG. 6 and FIG. 7. The term “uncertainty” according to the present embodiment refers to aleatoric uncertainty.

FIG. 6 illustrates an example of an image with high uncertainty and an image with low uncertainty that are obtained by data augmentation according to the present embodiment. FIG. 6 illustrates image 50a and image 50b obtained by applying different 20 image processing to original image 50. Image 50a is an example of an image with low uncertainty and image 50b is an example of an image with high uncertainty. It is clear that low-uncertainty image 50a includes the objects in image 50, while it is unclear that high-uncertainty image 50b includes the objects in image 50.

FIG. 7 illustrates another example of an image with high uncertainty and an image with low uncertainty that are obtained by data augmentation according to the present embodiment. FIG. 7 illustrates image 51a and image 51b obtained by applying different image processing to original image 51. Image 51a is an example of an image with low uncertainty and image 51b is an example of an image with high uncertainty. In a similar manner, it is clear that low-uncertainty image 51a includes the objects in image 51, while it is unclear that high-uncertainty image 51b includes the objects in image 51.

On the other hand, according to learning system 1 and the learning method according to the present embodiment described above, it is possible to take into account image uncertainty in self-supervised learning.

More specifically, each of the two neural networks is a variational autoencoder that transforms the input data into a latent variable that follows a probability distribution. Self-supervised learning is performed with the probability distribution that is defined, for example, by a hypersphere. With this, when two items of image data obtained by data augmentation include an image with high uncertainty, it is possible to reduce the contribution of such an image to learning, and when the two items of image data obtained by data augmentation include an image with low uncertainty, it is possible to increase the contribution of such an image to learning. In other words, learning system 1 and the learning method according to the present embodiment are capable of learning parameters that can take image uncertainty into account, so that self-supervised learning can be performed which takes image uncertainty into account. Therefore, even when the two items of image data obtained by data augmentation includes an image with high uncertainty, it is possible to reduce the adverse effects on learning, leading to a further improved accuracy.

In the following, a specific aspect in which the latent variables predicted (transformed) by two neural networks follow probability distributions defined by a hypersphere and a delta function will be described as examples.

### Example 1

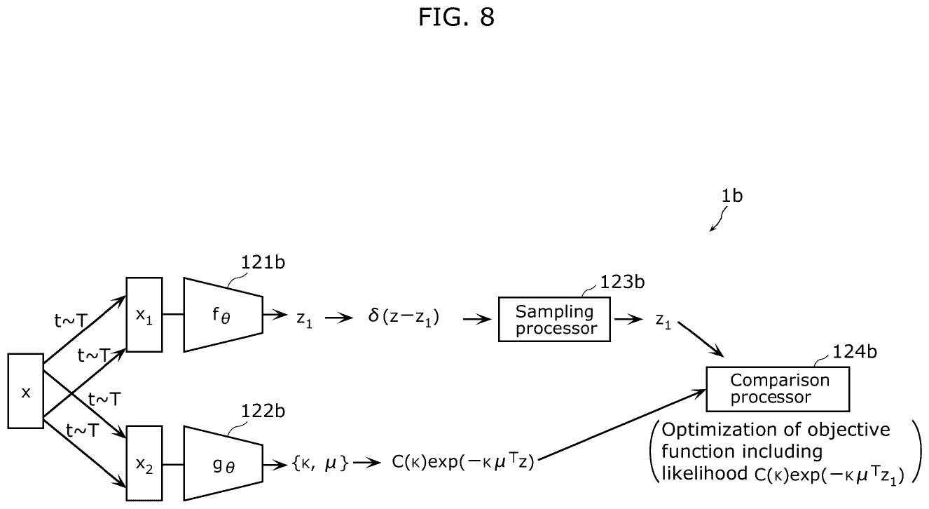

FIG. 8 conceptually illustrates processes performed by learning system 1b according to Example 1. The structural elements similar to those in FIG. 2 are marked with the same reference numerals, and are not described in detail. Learning system 1b, neural network 121b, and neural network 122b illustrated in FIG. 8 are examples of specific aspects of learning system 1, neural network 121, and neural network 122 illustrated in FIG. 1. In a similar manner, sampling processor 123b and comparison processor 124b illustrated in FIG. 8 are examples of specific aspects of sampling processor 123 and comparison processor 124 illustrated in FIG. 1.

In Example 1, as illustrated in FIG. 8, first parameter z₁ predicted by one neural network 121b follows probability distribution q defined by a delta function. First parameter z₁ is a latent variable that is predicted by neural network 121b.

More specifically, in Example 1, probability distribution q is defined by a delta function with a probability only at z₁, as indicated in (Formula 1).

$$[ Math . 1 ]$$

$$q ( z \vert {x}_{1} ; {Θ}_{1} ) := δ ( z - {z}_{1} ) \qquad ( Formula 1 )$$

Here, Θ₁=z₁ is satisfied.

Moreover, as illustrated in FIG. 8, second parameter z₂ predicted by the other neural network 122b follows probability distribution p defined by the von Mises-Fischer distribution. Second parameter z₂ is a latent variable predicted by neural network 122b. The von Mises-Fischer distribution is an example of a hypersphere, and can also be called a normal distribution on a sphere.

More specifically, in Example 1, probability distribution p is defined by the von Mises-Fischer distribution with two parameters that are mean direction u and concentration κ, as indicated in (Formula 2).

$$[ Math . 2 ]$$

$$p ( z \vert {x}_{2} ; {Θ}_{2} ) := C ( κ ) exp ( - κ {μ}^{T} z ) \qquad ( Formula 2 )$$

Here, Θ₂={κ, μ} is satisfied. C(κ) is a normalization constant, and is defined such that the product of probability distribution p is 1.

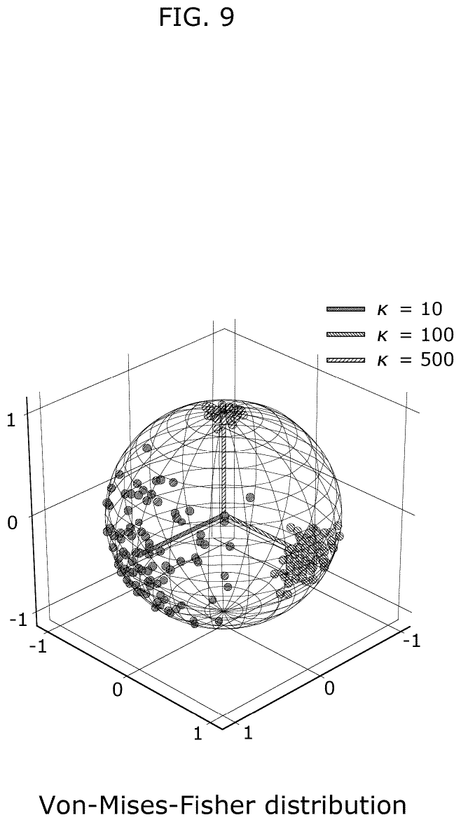

FIG. 9 conceptually illustrates an example of the von Mises-Fischer distribution.

As in the example illustrated in FIG. 9, in the von Mises-Fischer distribution, mean direction u represents the direction of increasing values in the distribution on the unit sphere, corresponding to the mean in a normal distribution. In the von Mises-Fischer distribution, concentration parameter κ represents the degree of concentration of the distribution in mean direction μ (how far from mean direction μ the value can be), corresponding to the inverse of the variance in a normal distribution. Therefore, the concentration of the distribution is higher when the value of concentration κ is 100 than when the value of concentration κ is 10, and when the value of concentration κ is 1000 than when the value of concentration κ is 100.

As described above, in the present example, the probability distribution of first parameter z₁ predicted by neural network 121b is probability distribution q defined by a delta function. Second parameter z₂ predicted by neural network 122b is a parameter that indicates mean direction μ and concentration parameter κ. Probability distribution p of the second parameter is the von Mises-Fischer distribution defined by mean direction μ and concentration parameter κ.

Moreover, in Example 1, too, sampling processor 123b performs a sampling process according to the delta function with a probability only at z₁. However, as illustrated in FIG. 8, sampling processor 123b passes first parameter z₁ predicted by neural network 121b as features z₁ as it is.

Comparison processor 124b inputs features z₁ passed by sampling processor 123b into probability distribution p of second parameter z₂, calculates the likelihood of probability distribution p of second parameter z₂ as indicated in (Formula 3), and calculates an objective function that includes the calculated likelihood.

$$[ Math . 3 ]$$

$$C ( κ ) exp ( - {κμ}^{T} {z}_{1} ) \qquad ( Formula 3 )$$

Moreover, comparison processor 124b is capable of training two neural networks that are neural network 121b and neural network 122b by optimizing the calculated objective function. Since the formula of the likelihood indicated in (Formula 3) includes the inner product represented by μ^{T}z₁, κ is reduced that is the inner product is reduced for an image with high uncertainty, so that the contribution of such an image to learning can be reduced. With this, comparison processor 124b is capable of performing an optimization process to maximize the similarity by bringing the first parameter and the second parameter as features obtained from image data X₁ and X₂ close to each other.

As described above, according to the present example, two neural networks are capable of learning the latent variable distribution that follows the probability distribution defined by the von Mises-Fischer distribution as parameters that can take image uncertainty into account. This allows the two neural networks to perform self-supervised learning that takes image uncertainty into account. Therefore, even when the two items of image data obtained by data augmentation include an image with high uncertainty, the adverse effect caused by learning two items of image data that include an image with high uncertainty can be reduced, leading to a further improved accuracy.

The following is an implementation example of learning system 1b and pseudocode according to Example 1.

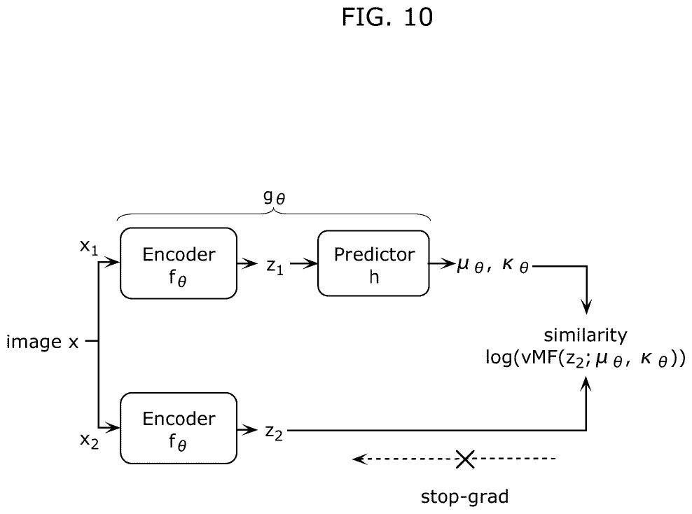

FIG. 10 illustrates an example of an architecture for implementing learning system 1b according to Example 1. The architecture illustrated in FIG. 10 includes encoders f and predictor h, following the architecture disclosed in NPL 1 which is a comparative example. Encoder f and predictor h in the top row in FIG. 10 correspond to neural network 121b, and performs a prediction process on image data X₁ obtained by applying data augmentation to input image X. Encoder f in the bottom row in FIG. 10 corresponds to neural network 122b, and performs a prediction process on image data X₂ obtained by applying data augmentation to input image X.

More specifically, predictor h illustrated in FIG. 10 predicts, as the second parameter, concentration parameter κ_{θ} and mean direction μ_{θ} which define the distribution of the latent variable. Concentration parameter κ_{θ} is related to the uncertainty of input image X and depends on model parameter θ of encoder f_{θ} and predictor h. Moreover, encoder f_{θ} in the bottom row in FIG. 10 predicts latent variable z₂ as the first parameter.

Use of KL divergence allows quantification of the similarity between the von Mises-Fischer distribution (probability distribution) defined by concentration parameter κ_{θ} and mean direction μ_{θ} and the probability distribution defined by latent variable z₂. Hence, KL divergence is used as the objective function. In the example illustrated in FIG. 10, likelihood vMF(z₂; μ_{θ}, κ_{θ}) is calculated by inputting latent variable z₂ into the von Mises-Fischer distribution defined by concentration parameter κ_{θ} and mean direction μ_{θ}. The objective function is then optimized by finding the likelihood that minimizes the KL divergence. In this way, encoder f and predictor h in the top row can be trained, so that two neural networks, which are encoder f and predictor h in the top row and encoder f in the bottom row, can be trained. Note that in the bottom row, stop-gradient is performed which does not update model parameters such as weights during backpropagation calculation. However, since encoder f in the bottom row and encoder f in the top row are the same neural network, when encoder f in the top row is trained, encoder f in the bottom row can be treated as it has also been trained.

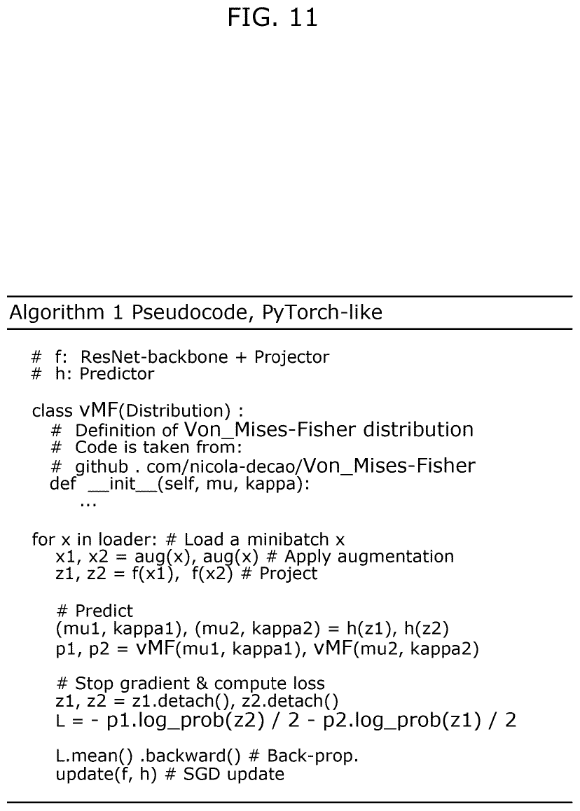

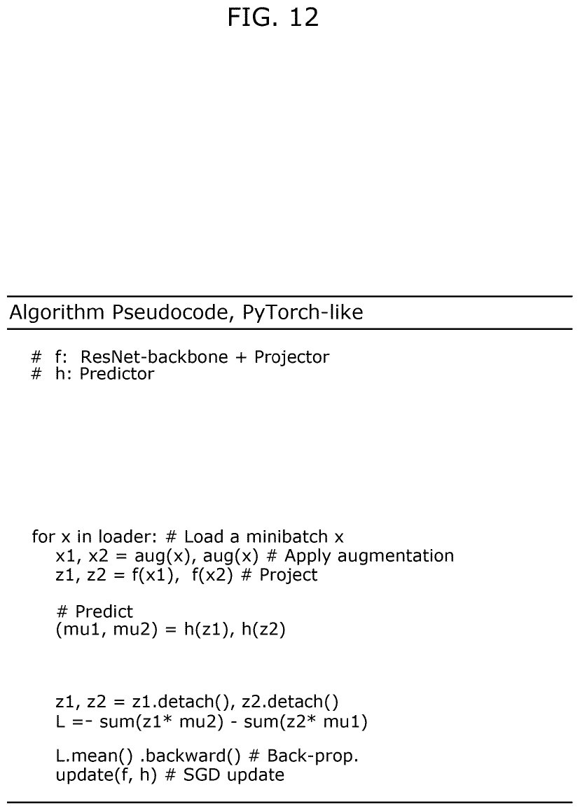

FIG. 11 illustrates an example of pseudocode of algorithm 1 according to Example 1. FIG. 12 illustrates pseudocode of an algorithm according to a comparative example. Algorithm 1 illustrated in FIG. 11 corresponds to the processing performed by learning system 1b according to Example 1, and specifically corresponds to the learning processing in the architecture illustrated in FIG. 10. The algorithm according to the comparative example illustrated in FIG. 12 corresponds to the learning processing in the Siamese network disclosed in NPL 1.

As can be seen by comparison between FIG. 11 and FIG. 12, algorithm 1 differs from the algorithm according to the comparative example in that predictor h predicts the concentration parameter κ and mean direction μ that define the von Mises-Fischer distribution. Therefore, algorithm 1 includes an objective function that is a loss function denoted by L, which is different from the algorithm according to the comparative example.

### Example 2

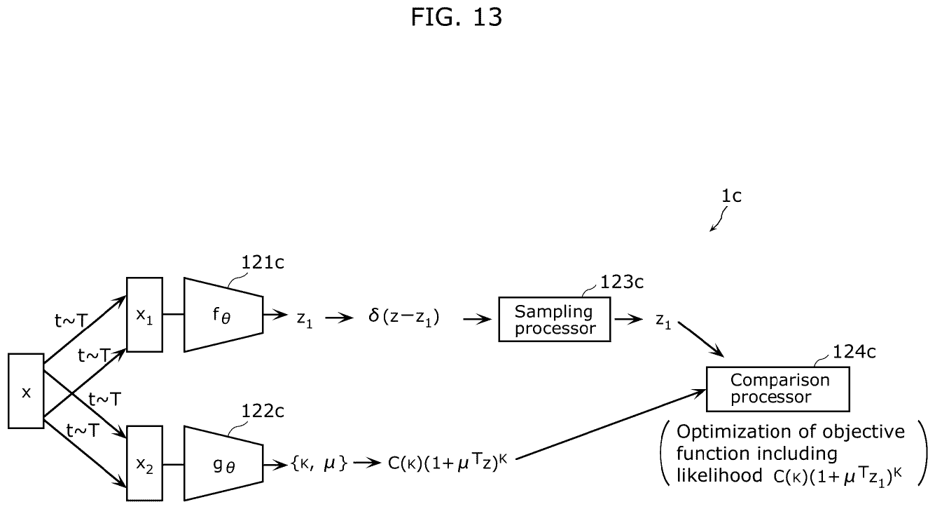

FIG. 13 conceptually illustrates processes performed by learning system 1c according to Example 2. The structural elements similar to those in FIG. 2 and FIG. 8 are marked with the same reference numerals, and are not described in detail.

Learning system 1c, neural network 121c, and neural network 122c illustrated in FIG. 13 are examples of specific aspects of learning system 1, neural network 121, and neural network 122 illustrated in FIG. 1. In a similar manner, sampling processor 123c and comparison processor 124c illustrated in FIG. 13 are examples of specific aspects of sampling processor 123 and comparison processor 124 illustrated in FIG. 1.

In Example 2, as illustrated in FIG. 13, first parameter z₁ predicted by one neural network 121c follows probability distribution q defined by a delta function. First parameter z₁ is a latent variable predicted by neural network 121c.

More specifically, in Example 2, too, probability distribution q is defined by a delta function with a probability only at z₁, as indicated in (Formula 1).

On the other hand, as illustrated in FIG. 13, second parameter z₂ predicted by the other neural network 122c follows probability distribution p defined by the Power Spherical distribution. Second parameter z₂ is a latent variable predicted by neural network 122c. The Power Spherical distribution is an example of a hypersphere.

More specifically, in Example 2, probability distribution p is defined by the Power Spherical distribution with two parameters that are mean direction μ and concentration κ, as indicated in (Formula 4). The Power Spherical distribution is disclosed in NPL 2, and thus, a detailed explanation thereof is omitted. The Power Spherical distribution is a probability distribution that has improved back-propagation stability and sampling processing time which are issues in the von Mises-Fischer distribution. In other words, in the Power Spherical distribution, the unstable normalization constant C(κ) and large computational load in the von Mises-Fischer distribution have improved.

$$[ Math . 4 ]$$

$$p ( z \vert {x}_{2} ; {Θ}_{2} ) := C ( κ ) {( 1 + {μ}^{T} z )}^{κ} \qquad ( Formula 4 )$$

Here, Θ₂={κ, μ} is satisfied, and C(κ) is a normalization constant.

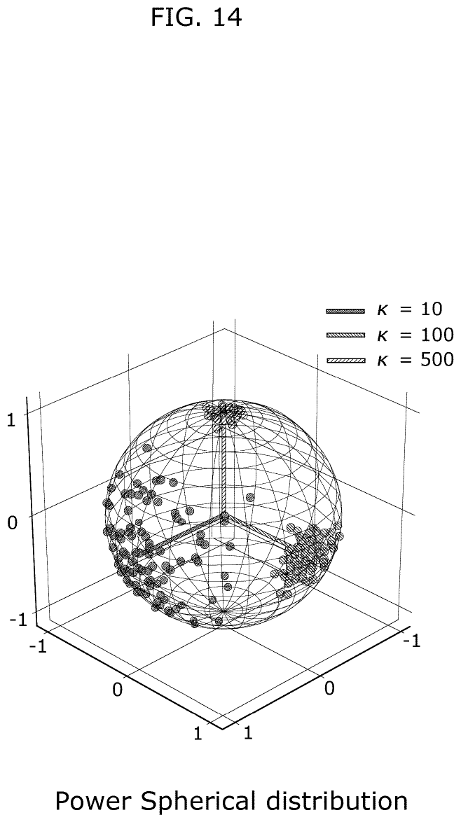

FIG. 14 conceptually illustrates an example of the Power Spherical distribution.

As in the example illustrated in FIG. 14, in the Power Spherical distribution, too, mean direction μ represents the direction of increasing value in the distribution on the unit sphere. In addition, in the Power Spherical distribution, too, concentration parameter κ represents the degree of concentration of the distribution in mean direction μ (how far from mean direction μ the value can be). Therefore, the concentration of the distribution is higher when the value of concentration parameter κ is 100 than when the value of concentration κ is 10, and when the value of concentration κ is 1000 than when the value of concentration κ is 100.

As described above, in the present example, the probability distribution of first parameter z₁ predicted by neural network 121c is probability distribution q defined by a delta function. Second parameter z₂ predicted by neural network 122c is a parameter indicating mean direction μ and concentration κ. Probability distribution p of the second parameter is the Power Spherical distribution defined by mean direction μ and concentration κ.

In a similar manner to Example 1, sampling processor 123c performs a sampling process according to the delta function with a probability only at z₁. However, as illustrated in FIG. 13, sampling processor 123c passes first parameter z₁ predicted by neural network 121c as it is.

Comparison processor 124c inputs features z₁ passed by sampling processor 123c into probability distribution p of second parameter z₂, calculates the likelihood of probability distribution p of second parameter z₂ as indicated in (Formula 5), and calculates an objective function that includes the calculated likelihood.

$$[ Math . 5 ]$$

$$C ( κ ) {( 1 + {μ}^{T} {z}_{1} )}^{κ} \qquad ( Formula 5 )$$

Comparison processor 124c is also capable of training two neural networks that are neural network 121c and neural network 122c by optimizing the calculated objective function. The formula of the likelihood indicated in (Formula 5) includes the inner product represented by μ^{T}z₁. Hence, the contribution of learning can be reduced for an image with high uncertainty by reducing κ, i.e., by reducing the inner product. This allows comparison processor 124c to perform an optimization process to maximize similarity by bringing the first and second parameters as features obtained from image data X₁ and X₂ close to each other.

As described above, this example allows the two neural networks to learn the distribution of latent variables that follow the probability distribution defined by the Power Spherical distribution as parameters that are capable of taking image uncertainty into account. This allows the two neural networks to perform self-supervised learning that takes image uncertainty into account. Therefore, even when the two items of image data obtained by data augmentation includes an image with high uncertainty, it is possible to reduce the adverse effects of learning two items of image data including an image with high uncertainty, leading to a further improved accuracy.

The following is an implementation example of learning system 1c and pseudocode according to Example 2.

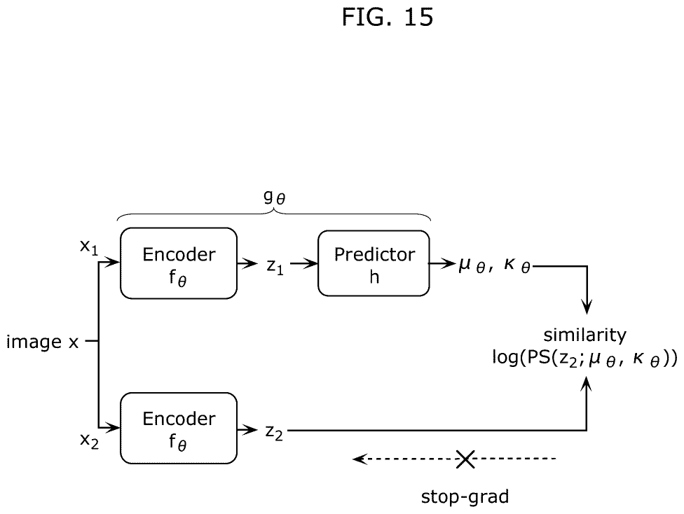

FIG. 15 illustrates an example of an architecture for implementing learning system 1c according to Example 2. In a similar manner to Example 1, encoder f and predictor h in the top row illustrated in FIG. 15 correspond to neural network 121c, and perform a prediction process on image data X₁ obtained by applying data augmentation to input image X. Encoder f in the bottom row in FIG. 15 corresponds to neural network 122c, and performs a prediction process on image data X₂ obtained by applying data augmentation to input image X.

More specifically, predictor h illustrated in FIG. 15 predicts concentration parameter κ_{θ} and mean direction μ_{θ}, which define the distribution of the latent variable, as the second parameter. Concentration parameter κ_{θ} is related to the uncertainty of input image X, and depends on model parameter θ of encoder f_{θ} and predictor h. Moreover, encoder f_{θ} in the bottom row predicts latent variable z₂ as the first parameter.

Use of KL divergence allows quantification of the similarity between the von Mises-Fischer distribution (probability distribution) defined by concentration parameter κ_{θ} and mean direction μ_{θ} and the probability distribution defined by latent variable z₂. Hence, KL divergence is used as the objective function. In the example illustrated in FIG. 15, likelihood PS (z₂;μ_{θ}, κ_{θ}) is calculated by inputting latent variable z₂ into the Power Spherical distribution defined by concentration parameter κ_{θ} and mean direction μ_{θ}. The objective function is then optimized by finding the likelihood that minimizes the KL divergence. In this way, encoder f and predictor h in the top row can be trained, so that two neural networks, which are encoder f and predictor h in the top row and encoder f in the bottom row can be trained.

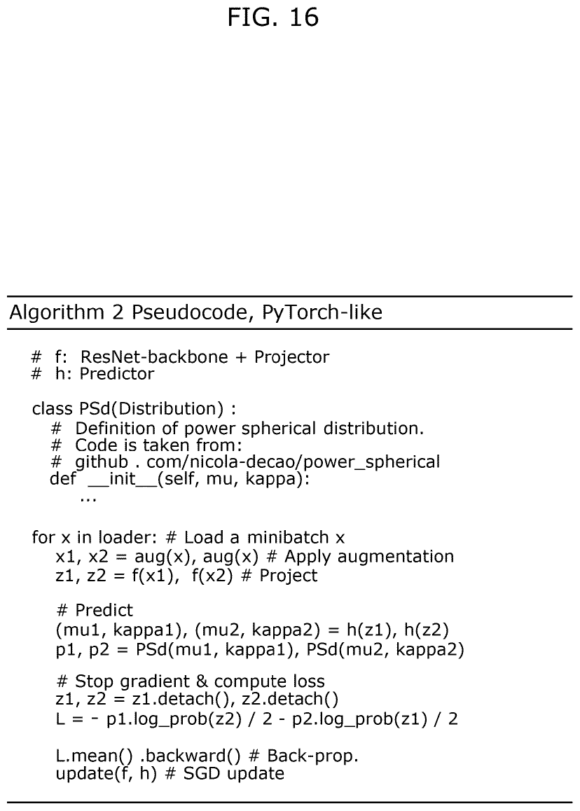

FIG. 16 illustrates an example of pseudocode of Algorithm 2 according to Example 2. Algorithm 2 illustrated in FIG. 16 corresponds to the processes performed by learning system 1c according to Example 2, specifically, the learning processes in the architecture illustrated in FIG. 15.

As can be seen by comparison between FIG. 16 and FIG. 12, Algorithm 2 differs from the algorithm according to the comparative example in that predictor h predicts concentration parameter κ and mean direction μ that define the Power Spherical distribution. Therefore, algorithm 2 is different from the algorithm according to the comparative example in an objective function that is the loss function denoted by L.

Comparing FIG. 12 and FIG. 16, the only difference is that the concentration parameter κ and mean direction μ, which define the Power Spherical distribution, are predicted instead of the von Mises-Fischer distribution, and the other processes are similar.

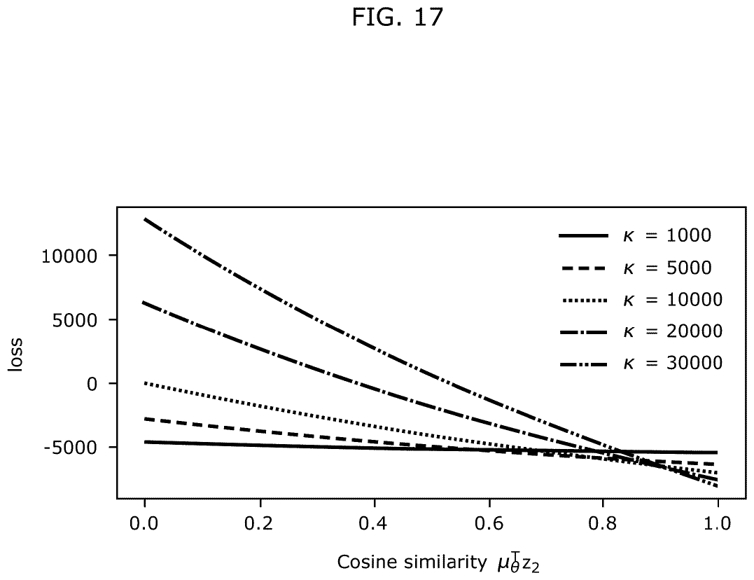

FIG. 17 illustrates a relationship between concentration parameter κᵢ, cosine similarity, and loss in learning system 1c according to Example 2. The loss is the loss between the probability distribution of latent variable z₂ that is the first parameter, and the Power Spherical distribution that is defined by concentration parameter κᵢ and mean direction μ_{θ} (second parameter). The cosine similarity is expressed by inner product u_{θ}^{T}z₂ of mean direction μ_{θ} and latent variable z₂.

As illustrated in FIG. 17, when concentration parameter κ is constant, the closer the cosine similarity is to zero, i.e., the less similar the two probability distributions are, the greater the loss. FIG. 17 also illustrates that as concentration parameter κ becomes smaller, the loss is less affected by the value of the cosine similarity. This prevents a significant increase in loss by reducing κ when the uncertainty in image data X₁ obtained by data augmentation makes it difficult to estimate mean direction μ similar to the latent variable z₂. This allows such learning to be performed that, when two items of image data obtained by data augmentation includes an image with high uncertainty, contribution of such an image to learning is small, and when the two items of image data obtained by data augmentation includes an image with low uncertainty, contribution of such an image to learning is large.

### Experiment Example

The advantageous effects of the learning method and the like according to Example 2 were verified by performing self-supervised learning using the datasets of imagenette and imagewoof which are subsets of the ImageNet dataset, and will be described below as an experiment example.

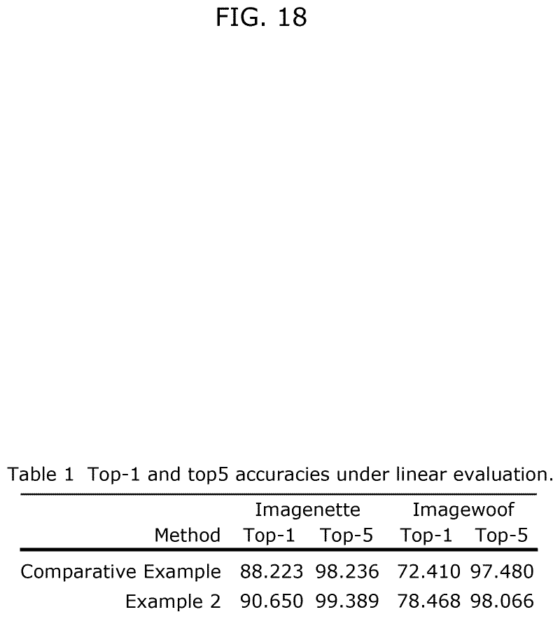

FIG. 18 illustrates the results of evaluating the performance of learning system 1c according to Example 2 using the datasets according to the experiment example. Example 2 illustrated in FIG. 18 corresponds to the results of evaluating the performance of the architecture when implementing learning system 1c according to Example 2. FIG. 18 also illustrates the results of evaluating the performance of the Siamese network disclosed in NPL 1 as a comparative example. In the evaluation results, Top1 accuracy and Top5 accuracy were used as evaluation indices.

The imagenette dataset includes ten classes of data that are easy to classify, and includes training dataset and evaluation dataset. On the other hand, the imagewoof dataset includes ten classes of data that are difficult to classify, and includes training dataset and evaluation dataset. In this experiment example, self-supervised learning was performed using all of the training datasets. On the other hand, when training a linear classifier for evaluation, approximately 20% of the training dataset was used for tuning the model parameters.

Encoder f used in the experiment example was configured from a backbone network and multi layer perceptron (MLP). Resnet18 was used as the backbone network. In addition, the MLP had three fully-connected layers (fc layers), and a batch normalization (BN) layer was applied to each layer. As the activation function, rectified linear unit (ReLU) was applied to all layers excluding the output layer. The dimensions of the input and hidden layers were set to 2048 dimensions.

Predictor h used in the experiment example was configured from an MLP with two fully-connected layers. The BN and ReLU activation functions were applied to the first fully-connected layer. The dimension of the input layer was set to 512 dimensions and the dimension of the output layer was set to 2049 dimensions. The dimension of the output layer of predictor h according to the comparative example was set to 2048 dimensions.

In addition, in this experiment example, momentum SGD was used for learning, and the learning rate was set to 10⁻³. The batch size was set to 64 and the number of epochs was set to 200. Layer-wise Adaptive Rate Scaling (LARS) was used to optimize the linear classifier for evaluation, with a learning rate of 1.6 and a batch size of 512.

From the evaluation results illustrated in FIG. 18, it can be seen that the Top1 and Top5 accuracies for the imagenette and imagewoof datasets are higher in Example 2 than in the comparative example.

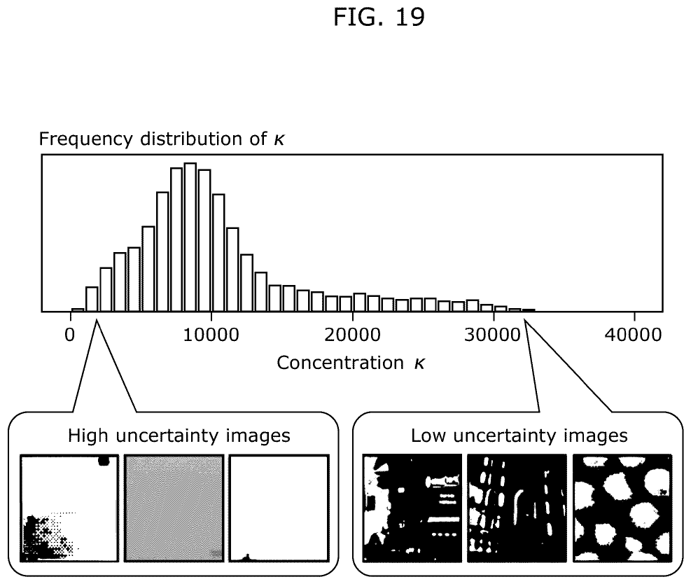

FIG. 19 illustrates the results of evaluating image uncertainty after data augmentation used in the experiment example. FIG. 19 illustrates a histogram of the frequency distribution of concentration parameters κ predicted for images after data augmentation. The evaluation results illustrated in FIG. 19 indicate that it is difficult to recognize what are shown in images with high concentration parameters κ predicted and such images have low uncertainty. On the other hand, the evaluation results illustrated in FIG. 19 indicate that what are shown in images with low concentration parameters κ predicted (such as trucks, buildings, and golf balls) can be recognized and such images have high uncertainty.

With the learning method and the like according to Example 2, the parameters of the probability distribution corresponding to the uncertainty of the image can be learned, meaning that uncertainty of the input image can be learned.

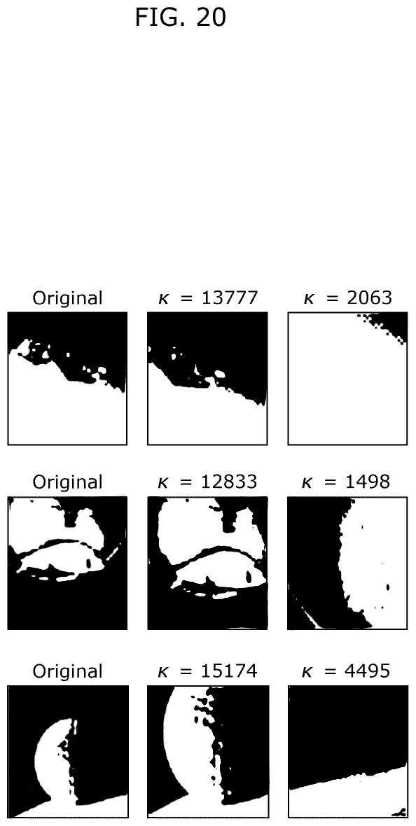

FIG. 20 illustrates concentration parameters κ predicted for images after data augmentation. FIG. 20 illustrates concentration parameters κ predicted for images obtained by applying data augmentation to the original images (Original) before data augmentation. The examples illustrated in FIG. 20 also indicate that it is difficult to recognize what are shown in images with high concentration parameters κ predicted, while images with low concentration parameters κ predicted can be recognized and have high uncertainty.

### (Variation 1)

In Examples 1 and 2 above, the examples have been described in which the latent variables of the feature representations predicted by two neural networks follow a probability distribution defined by a hypersphere and a delta function. However, the present disclosure is not limited to such an example.

The latent variables of the feature representations predicted by the two neural networks may follow a probability distribution defined by a joint distribution of discrete probability distributions. Such a case will be described below as Variation 1.

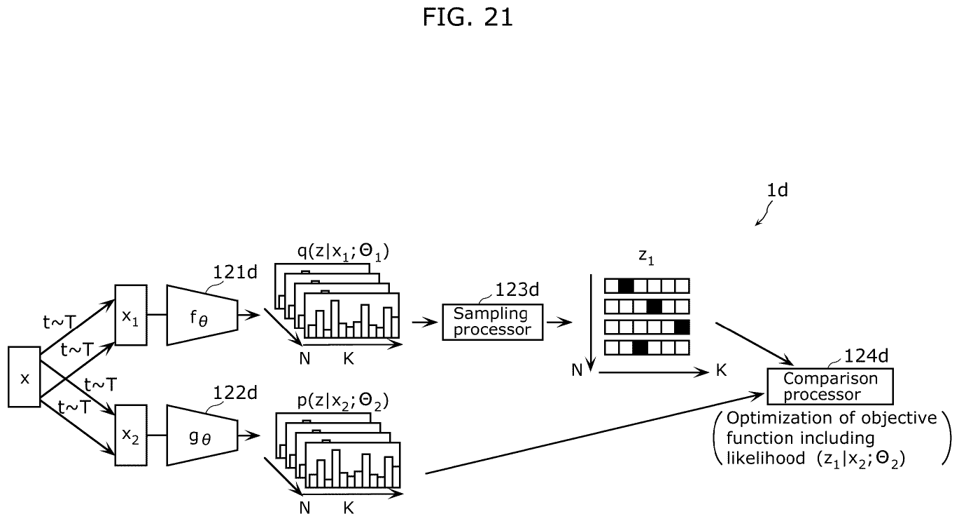

FIG. 21 conceptually illustrates processes performed by learning system 1d according to Variation 1. The structural elements similar to those in FIG. 2 are marked with the same reference numerals, and are not described in detail. Learning system 1d, neural network 121d, and neural network 122d illustrated in FIG. 21 are examples of specific aspects of learning system 1, neural network 121, and neural network 122 illustrated in FIG. 1. In a similar manner, sampling processor 123d and comparison processor 124d illustrated in FIG. 21 are examples of specific aspects of sampling processor 123 and comparison processor 124 illustrated in FIG. 1.

In Variation 1, as illustrated in FIG. 21, first parameter Θ₁ predicted by one neural network 121d follows probability distribution q(z|x₁;Θ₁) defined by a joint distribution of N discrete probability distributions (K classes). First parameter Θ₁ is a latent variable that is predicted by neural network 121d.

As illustrated in FIG. 21, second parameter Θ₂ predicted by the other neural network 122d follows probability distribution p(z|x₂; Θ₂) defined by the joint distribution of N discrete probability distributions (K classes). Second parameter Θ₂ is a latent variable predicted by neural network 122d.

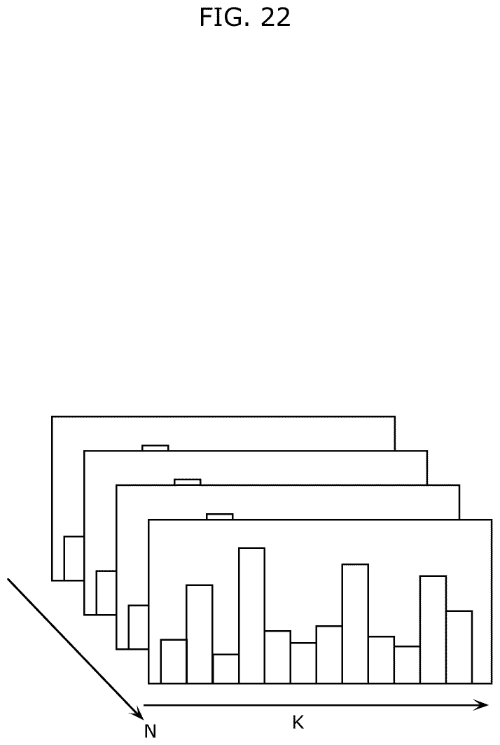

FIG. 22 conceptually illustrates the joint distribution of N discrete probability distributions (K classes).

As illustrated in the example in FIG. 22, the joint distribution of N discrete probability distributions (K classes) is a distribution indicating N discrete probability distributions of K classes simultaneously. When each discrete probability distribution is, for example, a probability distribution of a dice, then the K classes indicated by the horizontal axis is six classes, and the vertical axis indicates the frequency of each dice roll.

Thus, in the present variation, each of the probability distribution of first parameter Θ₁ predicted by neural network 121d and the probability distribution of second parameter Θ₂ predicted by neural network 122d may be a joint discrete probability distribution of one or more discrete probability distributions. Each of the discrete probability distributions may include two or more categories.

In this case, sampling processor 123d may generate random number z₁ that follows the probability distribution of first parameter Θ₁. As illustrated in FIG. 22, for example, sampling processor 123d may generate random number z₁ by randomly extracting the value of one of the K classes in each of the N discrete probability distributions.

Comparison processor 124d may input random number z₁ generated by sampling processor 123c into probability distribution p of second parameter z₂, calculate likelihood p(z₁|x₂;Θ₂) of probability distribution p of second parameter z₂, and calculate an objective function including the calculated likelihood p(z₁|x₂; Θ₂).

Then, comparison processor 124d may train two neural networks that are neural network 121d and neural network 122d by optimizing the calculated objective function.

As described above, the present variation allows the two neural networks to learn the distributions of latent variables that follow probability distributions defined by a joint distribution of discrete probability distributions as parameters that can take image uncertainty into account. This allows the two neural networks to perform self-supervised learning that takes image uncertainty into account. Therefore, even when two items of image data obtained by data augmentation may include an image with high uncertainty, the adverse effects of learning two items of image data including the image with high uncertainty can be reduced, leading to a further improved accuracy.

Next, simulation experiments conducted to confirm the advantageous effects of the learning method according to the present variation will be described below.

Simulation experiments were conducted to apply reinforcement learning to a robot controller from input images using features (parameters that follow a probability distribution) obtained by performing self-supervised learning with the configuration of learning system 1d illustrated in FIG. 21.

The controller of the robot, i.e., the model that controls the robot, was assumed to include neural network Π_{φ}. The inputs to neural network no are the features predicted by neural network 121d obtained by causing learning system 1d illustrated in FIG. 21 to perform self-supervised learning. In other words, the input to neural network Π_{φ} is the first parameter that follows the probability distribution that is the feature output by function f_{θ} of neural network 121d obtained by self-supervised learning.

Neural network 121d that operates f_{θ} was configured from a convolutional neural network and a recurrent neural network disclosed in NPL 3. Neural network 122d that operates g_{θ} was configured from a convolutional neural network that has the same configuration as the convolutional neural network of neural network 121d.

In this simulation experiment, neural network 121d and neural network 122d were first trained. Specifically, 1) an objective function including the inner product of the features of neural network 121d and neural network 122d was optimized, and 2) neural network 121d and neural network 122d performed self-supervised learning with optimization of the objective function according to the present example.

Next, reinforcement learning of neural network no was performed using, as inputs, the features obtained from neural network 121d and neural network 122d.

The software described in NPL 4 was used as the simulation environment for the robot, and evaluations were made on three kinds of tasks.

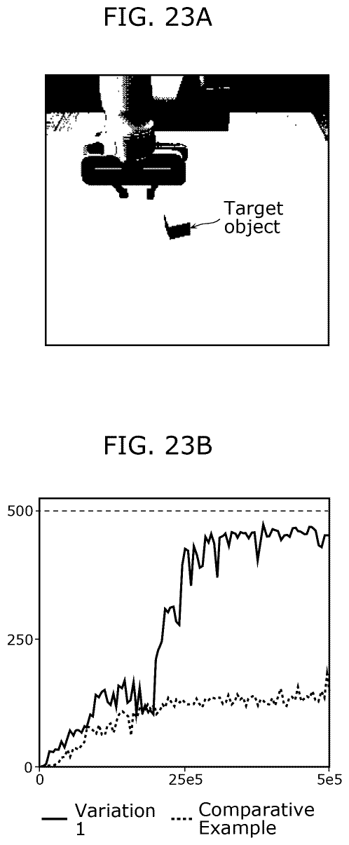

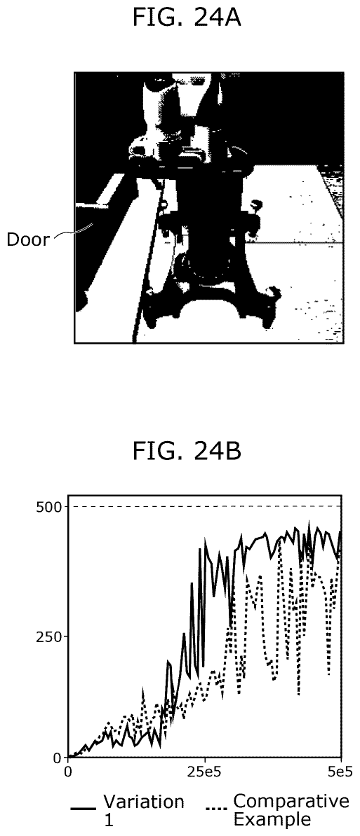

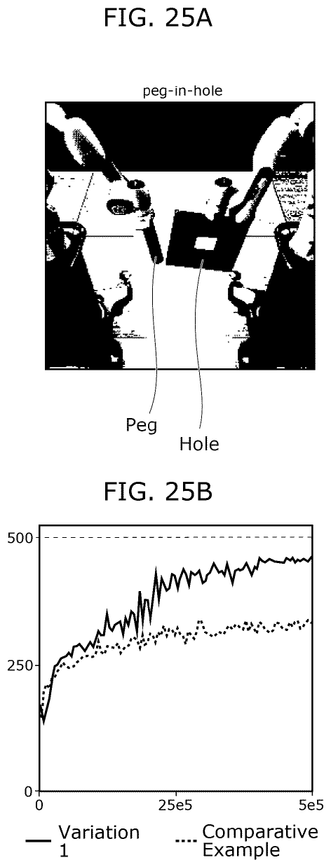

FIG. 23A to FIG. 25B illustrate the evaluation results for the three types of tasks according to the present variation. FIG. 23A, FIG. 24A, and FIG. 25A illustrate input images that are input to the controller of the robot to solve the three kinds of tasks. FIG. 23B, FIG. 24B, and FIG. 25B illustrate learning curves of the simulation experiments of the three kinds of tasks. In each of FIG. 23B, FIG. 24B, and FIG. 25B, the vertical axis represents the rewards of reinforcement learning, and the horizontal axis represents learning speed.

More specifically, FIG. 23A illustrates an example of a camera image that is input to the controller to cause the robot to solve a task of lifting a target object. FIG. 23B illustrates the learning curves of the simulation experiments that cause the robot to solve the task of lifting the target object. FIG. 24A illustrates an example of a camera image that is input to the controller to cause the robot to solve a task of opening a door. FIG. 24B illustrates the learning curves of the simulation experiments that cause the robot to solve the task of opening the door. FIG. 25A illustrates an example of a camera image that is input to the controller to cause the robot to solve a task of inserting a peg into a hole. FIG. 25B illustrates the learning curves of the simulation experiments that cause the robot to solve the task of inserting the peg into the hole. FIG. 23B, FIG. 24B, and FIG. 25B illustrate, as comparative examples, the cases where the features learned by the neural network disclosed in NPL 1 were used as inputs to neural network no which constitutes the controller of the robot.

As can be seen from FIG. 23B, FIG. 24B, and FIG. 25B, the learning speed has been improved in the present variation compared to the comparative example.

### (Variation 2)

In Example 1, Example 2, and Variation 1 above, it was assumed that the KL divergence indicated in (Formula 6) below was calculated as a loss.

$$[ Math . 6 ]$$

$${L}_{KL} = - {𝔼}_{q} [ log p ( z \vert \cdot ) ] + {𝔼}_{q} [ log q ( z \vert \cdot ) ] \qquad ( Formula 6 )$$

In addition, Example 1, Example 2, and Variation 1 above have been described assuming that the sampling process is performed to calculate the cross-entropy of the first term approximately as indicated in (Formula 7) with the second term as a constant. In (Formula 7), zᵢ is a random number sampled from probability distribution q.

$$[ Math . 7 ]$$

$${𝔼}_{q} [ log p ( z \vert \cdot ) ] ≃ {\sum }_{i} log p ( {z}_{i} \vert \cdot ) \qquad ( Formula 7 )$$

However, the loss as indicated in (Formula 6) may be calculated analytically, not just approximately. In both cases, this is because it is possible to cause the computer to optimize the objective function. Note that in this case, it is not essential to perform the sampling process.

Moreover, in Example 1 and Example 2, it has been described that the sampling process is performed according to the delta function with a probability only at z₁. However, since the sampling process passes z₁ as it is, it is not essential to perform the sampling process.

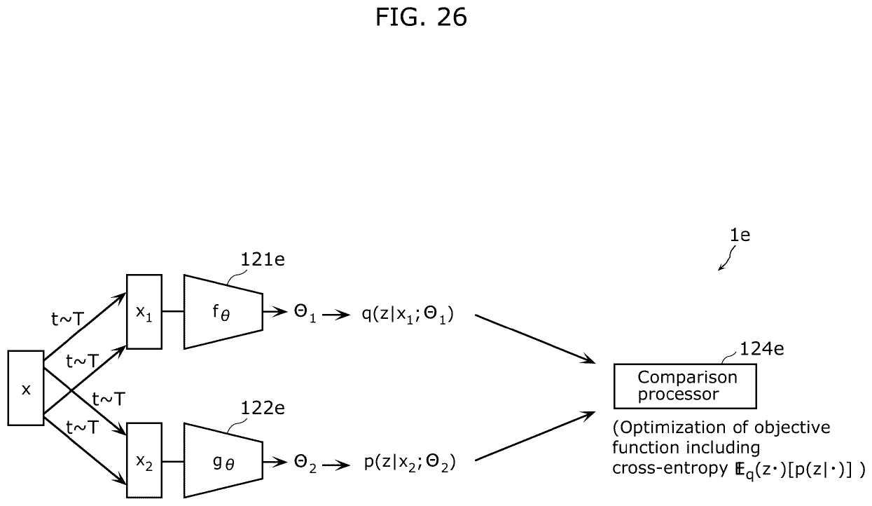

FIG. 26 conceptually illustrates processes performed by learning system 1e according to Variation 2. The structural elements similar to those in FIG. 2 are marked with the same reference numerals, and are not described in detail. Learning system 1e, neural network 121e, and neural network 122e illustrated in FIG. 26 are examples of specific aspects of learning system 1, neural network 121, and neural network 122 illustrated in FIG. 1. In a similar manner, comparison processor 124e illustrated in FIG. 26 is an example of a specific aspect of comparison processor 124 illustrated in FIG. 1.

In Variation 2, as illustrated in FIG. 26, first parameter Θ₁ predicted by one neural network 121e follows probability distribution q defined by a delta function. First parameter Θ₁ is a latent variable predicted by neural network 121e.

More specifically, in Variation 2, probability distribution q is defined by a delta function with a probability only at z₁ as indicated in (Formula 1). Probability distribution q may be defined by a joint distribution of discrete probability distributions.

Also, as illustrated in FIG. 26, second parameter Θ₂ predicted by the other neural network 122e follows probability distribution p defined by the von Mises-Fischer distribution or the Power Spherical distribution. Second parameter Θ₂ is a latent variable predicted by neural network 122e. More specifically, in Variation 2, probability distribution p is defined by the Von Mises-Fischer distribution or the Power Spherical distribution with two parameters that are mean direction μ and concentration κ, as indicated in (Formula 2) or (Formula 4).

When probability distribution q is defined by a joint distribution of discrete probability distributions, probability distribution p may also be defined by a joint distribution of discrete probability distributions.

In this case, comparison processor 124e is capable of calculating an objective function including the cross-entropy indicated in (Formula 8).

$$[ Math . 8 ]$$

$${𝔼}_{q ( z \cdot )} [ log p ( z \vert \cdot ) ] \qquad ( Formula 8 )$$

In other words, the objective function may include the cross-entropy of the probability distribution of first parameter Θ₁ and the cross-entropy of the probability distribution of second parameter Θ₂, and the cross-entropy of the probability distribution of second parameter Θ₂ may include the likelihood of the probability distribution of second parameter Θ₂.

Then, when training the two neural networks, comparison processor 124e may calculate the cross-entropy of probability distribution q of first parameter Θ₁ and the cross-entropy of probability distribution p of second parameter Θ₂ approximately or analytically. This allows comparison processor 124e to train two neural networks that are neural network 121e and neural network 122e to optimize the objective function.

When first parameter Θ₁ predicted by neural network 121e follows probability distribution q defined by a delta function, the loss indicated by Formula 6 that is the objective function can be calculated analytically using (Formula 9).

$$[ Math . 9 ]$$

$$q ( z \vert \cdot ) := δ ( z - {z}_{1} ) ⇒ {𝔼}_{q} [ log p ( z \vert \cdot ) ] = log p ( {z}_{1} \vert \cdot ) \qquad ( Formula 9 )$$

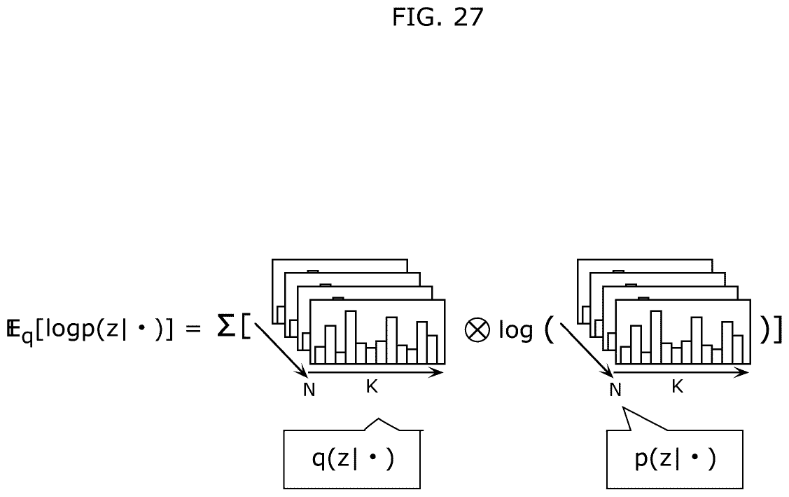

FIG. 27 conceptually illustrates a formula for analytically calculating the objective function according to Variation 2.

When probability distribution q(z|·) of first parameter Θ₁ and probability distribution p(z|·) of second parameter Θ₂ are probability distributions defined by the joint distribution of N discrete probability distributions (K classes), the loss indicated by (Formula 6) that is the objective function can be calculated analytically using the formula as indicated in FIG. 27.

### Other Possible Embodiments

Although the learning method and the like according to the embodiment has been described above, the entity or device in which each process is performed is not particularly limited. The processing may be performed by a processor or the like incorporated in a specific device disposed locally. The processing may also be performed by a cloud server or the like disposed in a place different from places where local devices are disposed.

Note that the present disclosure is not intended to be limited to the embodiment, examples, and variations described above. For example, the present disclosure may also include other embodiments that are implemented by any combination of structural elements described in the specification of the present disclosure or by excluding some structural elements. The present disclosure may also include variations obtained by applying various modifications conceivable by those skilled in the art to the embodiment described above without departing from the scope of the present disclosure, i.e., without departing from the languages recited in the scope of the claims.

The present disclosure further includes cases as described below.

(1) Each device described above is specifically a computer system configured by, for example, a microprocessor, a ROM, a RAM, a hard disk unit, a display unit, a keyboard, and a mouse. The RAM or the hard disk unit stores computer programs. Each device achieves its functions as a result of the microprocessor operating in accordance with the computer programs. Here, the computer programs are configured by a combination of a plurality of instruction codes that indicate commands given to the computer in order to achieve predetermined functions.

(2) Some or all of the structural elements of each device described above may be configured as single system large-scale integration (LSI). The system LSI is ultra-multifunctional LSI manufactured by integrating a plurality of components on a single chip, and specifically a computer system that includes, for example, a microprocessor, a ROM, and a RAM. The RAM stores computer programs. The system LSI achieves its functions as a result of the microprocessor operating in accordance with the computer programs.

(3) Some or all of the structural elements of each device described above may be configured as an IC card or a stand-alone module that is detachable from the device. The IC card or the module may be a computer system that includes, for example, a microprocessor, a ROM, and a RAM. The IC card or the module may include the ultra-multifunctional LSI described above. The IC card or the module achieves its functions as a result of the microprocessor operating in accordance with the computer programs. The IC card or the module may be tamper resistant.

(4) The present disclosure may be implemented as the methods described above. The present disclosure may also be implemented as a computer program that realizes these methods via a computer or as digital signals generated by the computer programs.

(5) The present disclosure may also be implemented by recording the computer programs or the digital signals on a computer-readable recording medium such as a flexible disk, a hard disk, a CD-ROM, an MO, a DVD, a DVD-ROM, a DVD-RAM, a Blu-ray (registered trademark) disc, or a semiconductor memory. The present disclosure may also be implemented as the digital signals recorded on such a recording medium.

The present disclosure may be implemented by transmitting the computer programs or the digital signals via, for example, telecommunication lines, wireless or wired communication lines, networks typified by the Internet, or data broadcasting.

The present disclosure may also be implemented as a computer system that includes a microprocessor and a memory and in which the memory stores the computer programs and the microprocessor operates in accordance with the computer programs.

The present disclosure may also be implemented as another independent computer system by transferring the programs or the digital signals recorded on the recording medium or by transferring the programs or the digital signals via the network or the like.

### INDUSTRIAL APPLICABILITY

The present disclosure is applicable to a learning method, a learning device, and a program for self-supervised learning with use of augmented image data.

1. A self-supervised representation learning method performed by a computer, the self-supervised representation learning method comprising:
outputting, using one of two neural networks, a first parameter that is a parameter of a probability distribution from one of two items of image data obtained by applying data augmentation to one training image obtained from training data;
outputting, using an other one of the two neural networks, a second parameter that is a parameter of a probability distribution from an other one of the two items of image data; and
training the two neural networks to optimize an objective function for bringing the two items of image data close to each other, the objective function including a likelihood of the probability distribution of the second parameter.

2. The self-supervised representation learning method according to claim 1, comprising:
performing a sampling process for generating a random number that follows the probability distribution of the first parameter; and
calculating a likelihood of the probability distribution of the first parameter, using the random number generated,
wherein, in the training of the two neural networks, the two neural networks are trained by inputting the random number generated to the probability distribution of the second parameter to calculate the likelihood of the probability distribution of the second parameter, and optimizing the objective function that includes the likelihood of the probability distribution of the second parameter calculated.

3. The self-supervised representation learning method according to claim 1,
wherein the probability distribution of the first parameter is a probability distribution defined by a delta function,
the second parameter is a parameter that indicates a mean direction and a concentration, and
the probability distribution of the second parameter is a von Mises-Fischer distribution defined by the mean direction and the concentration.

4. The self-supervised representation learning method according to claim 1,
wherein the probability distribution of the first parameter is a probability distribution defined by a delta function,
the second parameter is a parameter that indicates a mean direction and a concentration, and
the probability distribution of the second parameter is a Power Spherical distribution defined by the mean direction and the concentration.

5. The self-supervised representation learning method according to claim 1,
wherein each of the probability distribution of the first parameter and the probability distribution of the second parameter is a joint distribution of one or more discrete probability distributions, and
each of the one or more discrete probability distributions includes two or more categories.

6. The self-supervised representation learning method according to claim 1,
wherein the objective function includes a cross-entropy of the probability distribution of the first parameter and a cross-entropy of the probability distribution of the second parameter,
the cross-entropy of the probability distribution of the second parameter includes the likelihood of the probability distribution of the second parameter, and
in the training of the two neural networks, the two neural networks are trained to optimize the objective function by calculating the cross-entropy of the probability distribution of the first parameter and the cross-entropy of the probability distribution of the second parameter approximately or analytically.

7. A non-transitory computer-readable recording medium for use in a computer, the recording medium having recorded thereon a computer program for causing the computer to execute a self-supervised representation learning method comprising:
outputting, using one of two neural networks, a first parameter that is a parameter of a probability distribution from one of two items of image data obtained by applying data augmentation to one training image obtained from training data;
outputting, using an other one of the two neural networks, a second parameter that is a parameter of a probability distribution from an other one of the two items of image data; and
training the two neural networks to optimize an objective function for bringing the two items of image data close to each other, the objective function including a likelihood of the probability distribution of the second parameter.
